(19) United States
(12) Patent Application Publication
(10) Pub. No.: US 2026/0066379 A1
(43) Pub. Date: Mar. 5, 2026

(54) BATTERY PACK THERMAL BARRIER SECURING SYSTEM

(71) Applicant: Ford Global Technologies, LLC, Dearborn, MI (US)

(72) Inventors: Rajaram Subramanian, Ann Arbor, MI (US); Hari Krishna Addanki, Novi, MI (US); Steve Droste, Canton, MI (US); Suriyaprakash Ayyangar Janarthanam, Canton, MI (US)

(21) Appl. No.: 18/825,751

(22) Filed: Sep. 5, 2024

(51) Int. Cl. H01M 10/653; H01M 10/625

(52) U.S. Cl. CPC H01M 10/653; H01M 10/625; H01M 2220/20

(57) ABSTRACT

A traction battery pack assembly includes a cell stack having a plurality of battery cells and one or more thermal barriers disposed along a cell stack axis. A crossmember is alongside the cell stack. One or more fasteners that secure the one or more thermal barriers to the crossmember. The fasteners can be staples.

### TECHNICAL FIELD

This disclosure relates generally to securing thermal barriers of a battery pack and, more particularly, to securing the thermal barriers to a crossmember.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack assembly, including: a cell stack having a plurality of battery cells and one or more thermal barriers disposed along a cell stack axis; a crossmember alongside the cell stack; and one or more fasteners that secure the one or more thermal barriers to the crossmember.

In some aspects, the techniques described herein relate to a traction battery pack assembly, wherein the one or more fasteners are staples.

In some aspects, the techniques described herein relate to a traction battery pack assembly, wherein the one or more fasteners are U-shaped.

In some aspects, the techniques described herein relate to a traction battery pack assembly, wherein the crossmember includes a plurality of channels that open toward the cell stack, wherein the one or more thermal barriers project radially away from the cell stack axis and are each partially received within a respective channel within the plurality of channels.

In some aspects, the techniques described herein relate to a traction battery pack assembly, wherein adhesive bonds the one or more thermal barriers to the crossmember.

In some aspects, the techniques described herein relate to a traction battery pack assembly, wherein the adhesive is within the plurality of channels.

In some aspects, the techniques described herein relate to a traction battery pack assembly, wherein each of the channels in the plurality of channels extends longitudinally along a channel axis.

In some aspects, the techniques described herein relate to a traction battery pack assembly, wherein the one or more fasteners extends into the crossmember in a direction aligned with the channel axis.

In some aspects, the techniques described herein relate to a traction battery pack assembly, wherein the channel axis is a vertically extending axis, wherein the one or more fasteners extend downward into the crossmember.

In some aspects, the techniques described herein relate to a traction battery pack assembly, wherein the crossmember includes one or more notches that each receive a portion of the thermal barrier.

In some aspects, the techniques described herein relate to a traction battery pack assembly, wherein the one or more fasteners each span over one of the notches to engage the crossmember on either side of the notch and hold the portion with one of the notches.

In some aspects, the techniques described herein relate to a traction battery pack assembly, wherein the one or more notches each open upward, wherein the crossmember includes a plurality of channels that open toward the cell stack, each of the channels extending vertically downward from one of the notches wherein the one or more thermal barriers project radially away from the cell stack axis past the plurality of battery cells and are each partially received within a respective one of the channel within the plurality of channels.

In some aspects, the techniques described herein relate to a traction battery pack assembly, wherein the crossmember is a polymer-based material.

In some aspects, the techniques described herein relate to a traction battery pack assembly, wherein the crossmember includes a plurality of busbars, the plurality of battery cells having a plurality of tab terminals that are secured to at least one busbar within the plurality of busbars.

In some aspects, the techniques described herein relate to a traction battery pack assembly, wherein the plurality of tab terminals each extend through a respective slot in the crossmember.

In some aspects, the techniques described herein relate to a traction battery pack assembly, including: a crossmember frame; a plurality of busbars secured to the crossmember frame; a cell stack alongside the crossmember frame; a plurality of battery cells of the cell stack; the plurality of battery cells having tab terminals that extend through a slot in the crossmember frame and are secured to one or more of the busbars in the plurality of busbars; at least one thermal barrier of the cell stack; and at least one fastener securing the at least one thermal barrier to the crossmember frame.

In some aspects, the techniques described herein relate to a traction battery pack assembly, wherein the at least one thermal barrier is adhesively secured to the crossmember frame.

In some aspects, the techniques described herein relate to a traction battery pack assembly, wherein the at least one thermal barrier is at least partially received within a slot provided by the crossmember frame.

In some aspects, the techniques described herein relate to a traction battery pack assembly, wherein the at least one fastener is at least one staple.

In some aspects, the techniques described herein relate to a traction battery pack assembly, wherein the at least one fastener sandwiched a portion of the at least one thermal barriers against an upper surface of the crossmember frame.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a perspective view of a battery cell from the battery pack of FIG. 2.

FIG. 4 illustrates a perspective view of a thermal barrier from the battery pack of FIG. 2.

FIG. 5 is a close-up view of an area of FIG. 4 and shows portions of a crossmember alongside a cell stack of the battery pack of FIG. 2.

FIG. 6 shows a top view of the portions of the cell stack and crossmember of FIG. 5.

FIG. 7 is a view of the portions of the cell stack and the crossmember of FIG. 5 prior to the crossmember moving to an installed position with the cell stack.

FIG. 8 is a close-up view of an area of FIG. 6 with part of a T-top section of a thermal barrier removed to show an interior of a channel in the crossmember.

FIG. 9 shows a staple from the battery pack of FIG. 2 according to an exemplary embodiment of the present disclosure.

FIG. 10 shows a fastener from the battery pack of FIG. 2 according to another exemplary embodiment of the present disclosure.

### DETAILED DESCRIPTION

This disclosure details exemplary traction battery pack where thermal barriers of a cell stack are secured to a crossmember frame using fasteners, such as staples. The fasteners can hold a position of the thermal barriers of a cell stack as an adhesive cures to bond the thermal barriers to the crossmember frame. Battery cells of the cell stack can include tab terminals that extend through slots in the crossmember frame and are connected to the busbars.

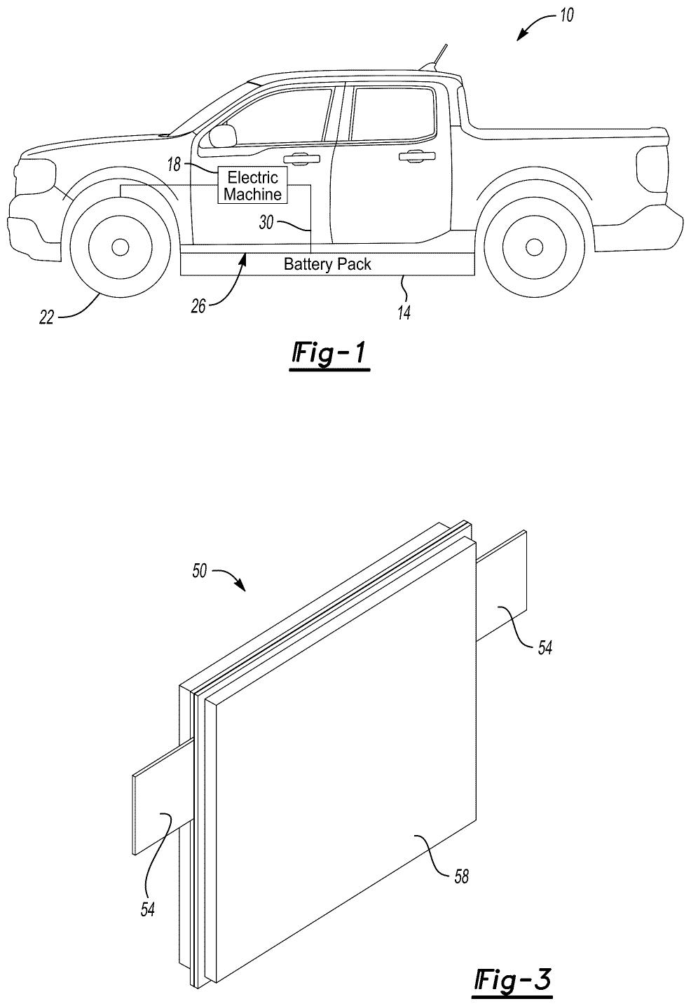

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

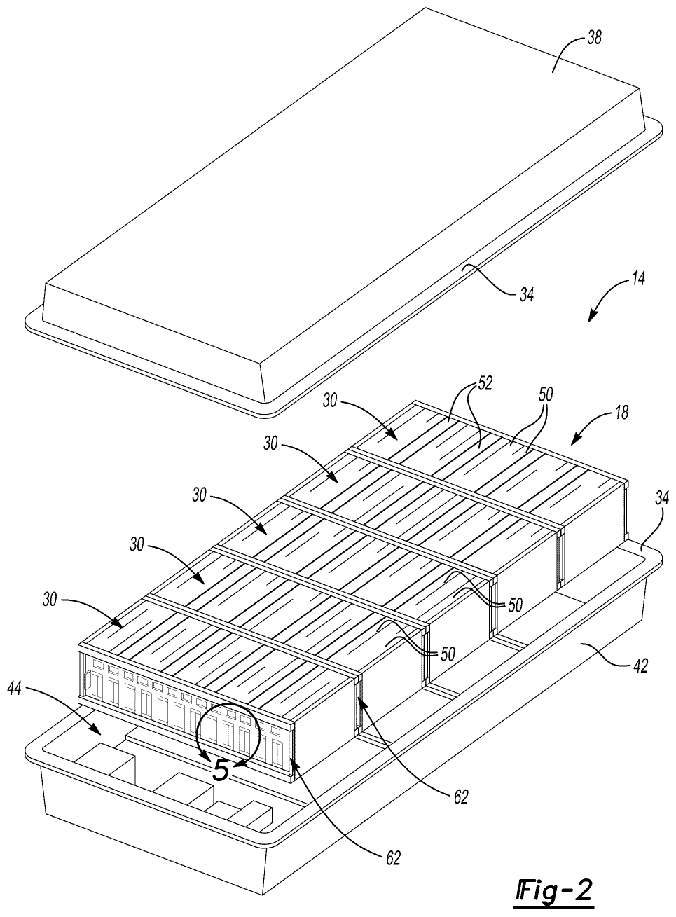

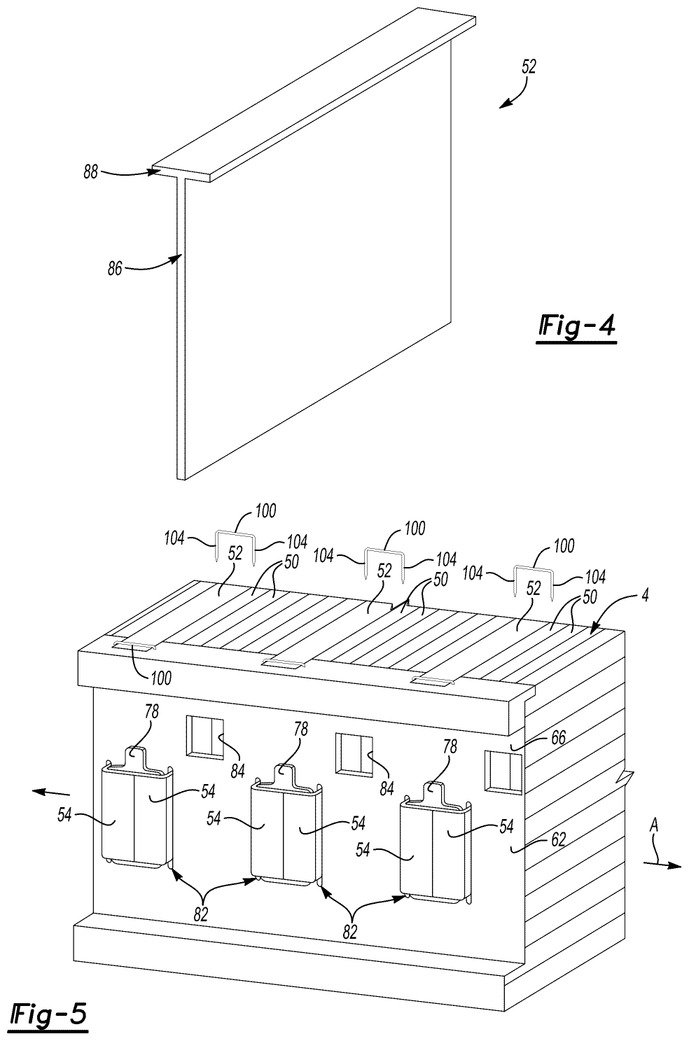

With reference now to FIG. 2-5 the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) and one or more thermal barriers 52 disposed along a respective cell stack axis A. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

With the cell stacks 30, the individual battery cells 50 can be electrically connected together. The cell stacks 30 can also be connected to each other. To facilitate these electrical connections, the battery cells 50 each include a pair of tab terminals 54 extending from a case 58. The tab terminals 54 of the battery cells 50 can be connected to the tab terminals 54 of other battery cells 50 and to other structures.

For instance, alongside the battery cells 50 are crossmembers 62. Each cell stack 30 is positioned between two crossmembers 62 in this example. The example crossmembers 62 each include a frame 66 and a plurality of busbars 78.

In the exemplary embodiment, the busbars 78 are heat-staked to the frame 66, which is a polymer-based material. The frame 66 could be injection molded. The frame 66 extends longitudinally a length of the cell stack 30.

When the cell stacks 30 are assembled, the tab terminals 54 extend through a plurality of slots 82 in the frame 66. The tab terminals 54 are folded over the busbars 78 and are secured to the busbars 78 via welds, for example.

The tab terminals 54 are typically thin strips of foil. The tab terminals 54 can be, for example, copper foil or aluminum foil.

The thermal barriers 52 project radially away from cell stack axis A. The thermal barriers 52 can help to compartmentalize the interior area 44. If, for example, one of the battery cells 50 undergoes a thermal event and begins to discharge vent byproducts, the thermal barriers 52 guide those vent byproducts outward away from the cell stack axis A through vent openings 84 in the frame 66. The thermal barriers 52 block movement of the vent byproducts along the cell stack axis A. Movement of the vent byproducts along the cell stack axis A toward other battery cells 50 that are not venting can increase thermal energy levels in those battery cells 50 and can lead to those battery cells 50 venting.

The example thermal barriers 52 have a T-shaped cross-sectional profile with a stem section 86 and a T-top section 88. The thermal barriers 52 can include mica material.

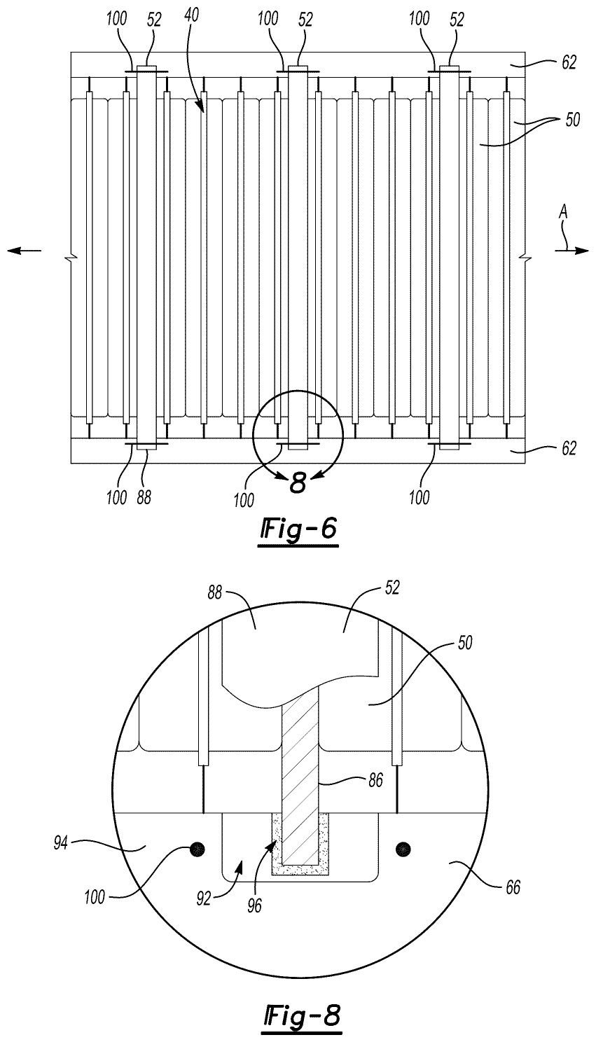

With reference to FIG. 6-8 and continuing reference to FIG. 2-5, each of the thermal barriers 52 include radially outer portions that are secured to the frame 66. In this example, the stem sections 86 of the thermal barriers 52 are each at least partially received within respective channels 90 in the frame 66. These channels 90 open toward the cell stack 30 when the crossmembers 62 are alongside the cell stack 40. The T-top sections 88 fit within respective notches 92 within an upper surface 94 of the frame 66. The notches 92 open vertically upward when the crossmembers 62 are alongside the cell stack 40. Vertical, for purposes of this disclosure is with reference to ground and an orientation of the battery pack 14 when installed within a vehicle 10.

During assembly, adhesive 96 is added to the channels 90. The crossmember 62 are then placed along the cell stack 30 so that the tab terminals 54 extend through the slots 82, the stem sections 86 are received within the channels 90, and the T-top sections 88 are received within the notches 92. The adhesive 96, when cured, holds the position of the thermal barriers 52 relative to the crossmember 62.

In some examples, the thermal barriers 52 may tend to stray from a desired position unless the adhesive is cured. This can be due to the cell stack 30 being compressed along the cell stack axis A, manufacturing tolerances, or for some other reasons. The positioning of the stem sections 86 within the channels 90 and the T-top sections 88 within the notches 92 can block some movement of the thermal barriers 52 relative to the frame 66, such as movement along the cell stack axis A. However, areas of the cell stack 30 may tend to flex upward lifting the T-top sections 88 out of the notches 92. Curing the adhesive 96 with the cell stack 40 flexed upward can result in alignment issues.

In the exemplary embodiment, one or more fasteners 100 are used to secure the thermal barriers 52 to the frame 66. The fasteners 100 secure the thermal barriers 52 just after introducing the stem sections 86 into the channels 90 and the T-top sections 88 into the notches 92. Fixtures can be used to hold a position of the cell stack 40 while the fasteners 100 are secured. The fixtures can then be removed. The fasteners 100 continue to hold the thermal barriers 52 in position after the fixtures are removed even if the adhesive 96 is not yet cured.

When secured, each of the fasteners 100 spans over a portion of one of the T-top sections 88 and engage the crossmember 62—here the crossmember frame 66—on either side of the respective notch 92 to sandwich the T-top section 88 against the upper surface 94 of the frame 66 within the respective notch 92.

The example fasteners 100 are staples. The fasteners 100 could be another type of fastener in another example, such as another type of U-shaped fastener or a spring clip. The fasteners 100 can be applied using a staple gun

The fasteners 100 include legs 104 that extend downward into the frame 66 on either side of the notch 92 and the T-top section 88. The legs 104 extend into the frame 66 in a direction aligned with a longitudinal axis of the channel 90. The longitudinal axes of the channels 90 are vertically extending in this example.

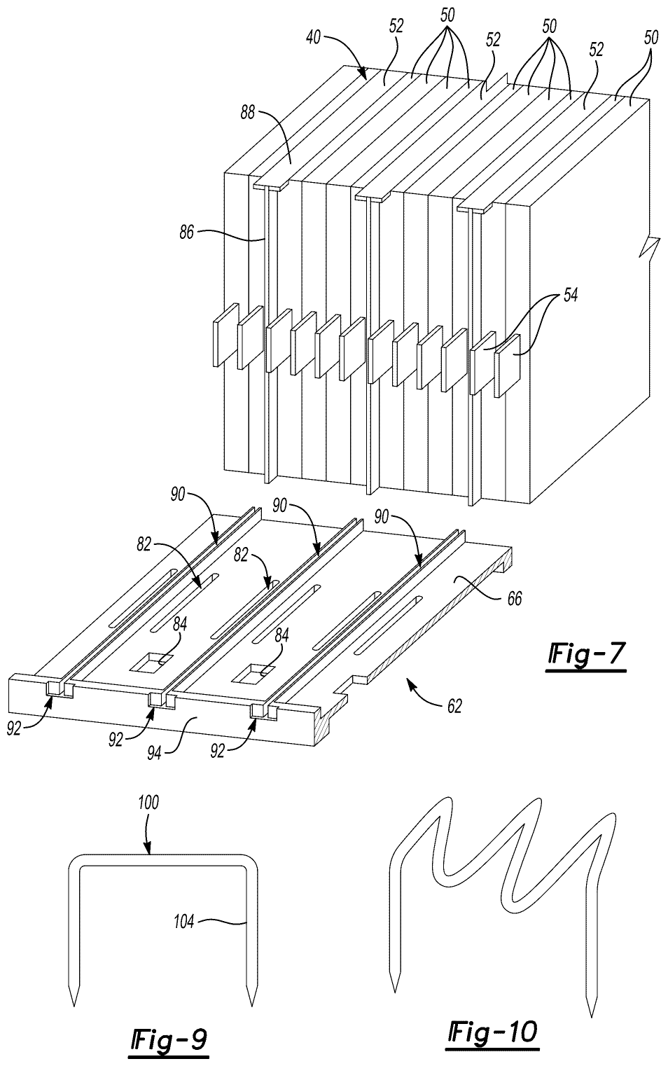

FIG. 9 shows an example of the fastener 100 used in the battery pack 14. Another example fastener 100A that could instead be used in the battery pack 14 is shown in FIG. 10.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack having a plurality of battery cells and one or more thermal barriers disposed along a cell stack axis;
a crossmember alongside the cell stack; and
one or more fasteners that secure the one or more thermal barriers to the crossmember.

2. The traction battery pack assembly of claim 1, wherein the one or more fasteners are staples.

3. The traction battery pack assembly of claim 1, wherein the one or more fasteners are U-shaped.

4. The traction battery pack assembly of claim 1, wherein the crossmember includes a plurality of channels that open toward the cell stack, wherein the one or more thermal barriers project radially away from the cell stack axis and are each partially received within a respective channel within the plurality of channels.

5. The traction battery pack assembly of claim 4, wherein adhesive bonds the one or more thermal barriers to the crossmember.

6. The traction battery pack assembly of claim 5, wherein the adhesive is within the plurality of channels.

7. The traction battery pack assembly of claim 4, wherein each of the channels in the plurality of channels extends longitudinally along a channel axis.

8. The traction battery pack assembly of claim 7, wherein the one or more fasteners extends into the crossmember in a direction aligned with the channel axis.

9. The traction battery pack assembly of claim 7, wherein the channel axis is a vertically extending axis, wherein the one or more fasteners extend downward into the crossmember.

10. The traction battery pack assembly of claim 1, wherein the crossmember includes one or more notches that each receive a portion of the thermal barrier.

11. The traction battery pack assembly of claim 10, wherein the one or more fasteners each span over one of the notches to engage the crossmember on either side of the notch and hold the portion with one of the notches.

12. The traction battery pack assembly of claim 10, wherein the one or more notches each open upward, wherein the crossmember includes a plurality of channels that open toward the cell stack, each of the channels extending vertically downward from one of the notches wherein the one or more thermal barriers project radially away from the cell stack axis past the plurality of battery cells and are each partially received within a respective one of the channel within the plurality of channels.

13. The traction battery pack assembly of claim 1, wherein the crossmember is a polymer-based material.

14. The traction battery pack assembly of claim 1, wherein the crossmember includes a plurality of busbars, the plurality of battery cells having a plurality of tab terminals that are secured to at least one busbar within the plurality of busbars.

15. The traction battery pack assembly of claim 14, wherein the plurality of tab terminals each extend through a respective slot in the crossmember.

16. A traction battery pack assembly, comprising:
a crossmember frame;
a plurality of busbars secured to the crossmember frame;
a cell stack alongside the crossmember frame;
a plurality of battery cells of the cell stack; the plurality of battery cells having tab terminals that extend through a slot in the crossmember frame and are secured to one or more of the busbars in the plurality of busbars;
at least one thermal barrier of the cell stack; and
at least one fastener securing the at least one thermal barrier to the crossmember frame.

17. The traction battery pack assembly of claim 16, wherein the at least one thermal barrier is adhesively secured to the crossmember frame.

18. The traction battery pack assembly of claim 17, wherein the at least one thermal barrier is at least partially received within a slot provided by the crossmember frame.

19. The traction battery pack assembly of claim 16, wherein the at least one fastener is at least one staple.

20. The traction battery pack assembly of claim 16, wherein the at least one fastener sandwiched a portion of the at least one thermal barriers against an upper surface of the crossmember frame.
